(19) United States
(12) Patent Application Publication
(10) Pub. No.: US 2011/0099636 A1
(43) Pub. Date: Apr. 28, 2011

(54) Read-only protection method for removable storage medium

(75) Inventors: Chia-Huang Tsai, Jhubei City (TW); Shang-Lang Chang, Jhbei City (TW)

(73) Assignee: INNOSTOR TECHNOLOGY CORPORATION

(21) Appl. No.: 12/660,648

(22) Filed: Mar. 2, 2010

(30) Foreign Application Priority Data
Oct. 22, 2009 (TW) 098135731

(51) Int. Cl. G06F 21/00; G06F 17/00; G06F 12/16

(52) U.S. Cl. 726/24; 707/690; 711/162; 707/E17.01; 707/E17.032; 711/E12.103

(57) ABSTRACT

A read-only protection method for removable storage medium has steps of establishing a copy prohibited list, receiving a write command for the removable storage medium, determining whether to allow duplication of data to the removable storage medium, allowing duplication of data to the removable storage medium when the data to be duplicated are not listed in the copy prohibited list and prohibiting duplication of data to the removable storage medium when the data to be duplicated are listed in the copy prohibited list. The method of the present invention prohibits copying of pre-designated data to the removable storage medium, but writing other data is allowed.

### BACKGROUND OF THE INVENTION

1. Field of the Invention

The present invention relates to a protection method for removable storage medium, and more particularly to a read-only protection method that prohibits copying of pre-designated files to the removable storage medium.

2. Description of Related Art

Removable storage mediums, such as Universal Serial Bus (USB) flash drives, removable hard discs or the like are used for convenient storage and transfer of data. However, since USB drives are connected to different devices, USB flash viruses have become a critical problem.

The USB flash viruses use a file in an operating system, such as the file “autorun.inf” in the Microsoft Windows, to spread the USB flash viruses. When the USB flash drive infected with the USB flash virus is connected to the computer, the operating system executes the autorun.inf file in the infected USB flash drive after detecting connection with the USB flash drive. Virus files in the USB flash drive infect the computer while the computer is executing the autorun.inf file. The infected computer further spreads the USB flash virus to other connected USB flash drives. Therefore, the USB flash viruses spread quickly.

To avoid infection of the USB flash viruses, a conventional USB flash drive has a read-only switch. The read-only switch allows a user to operate the USB flash drive in a read-only mode. When operating in the read-only mode, writing data to the USB flash drive is prohibited so the USB flash drive will not be infected with viruses.

However, neither the USB flash viruses nor clean files can be written to the USB flash drive when the USB flash drive operates in the read-only mode. Further, deletion of data in the USB flash drive is also not allowed when the USB flash drive operates in the read-only mode.

To overcome the shortcomings, the present invention provides a read-only protection method for removable storage medium to mitigate or obviate the aforementioned problems.

### SUMMARY OF THE INVENTION

The main objective of the present invention is to provide a read-only protection method for removable storage medium that prohibits pre-designated files from being copied to the removable storage medium.

The method in accordance with the present invention comprises steps of establishing a copy prohibited list, receiving a write command for the removable storage medium, determining whether to allow duplicating data to the removable storage medium, allowing duplicating data to the removable storage medium when the data to be duplicated are not listed in the copy prohibited list and prohibiting duplicating data to the removable storage medium when the data to be duplicated are listed in the copy prohibited list. The method of the present invention prohibits copying of pre-designated data to the removable storage medium, but writing other data is allowed.

Other objectives, advantages and novel features of the invention will become more apparent from the following detailed description when taken in conjunction with the accompanying drawings.

### BRIEF DESCRIPTION OF THE DRAWINGS

FIG. 1 is a functional diagram of a removable storage medium and a target computer; and

FIG. 2 is a flow chart of a method in accordance with the present invention.

### DETAILED DESCRIPTION OF PREFERRED EMBODIMENT

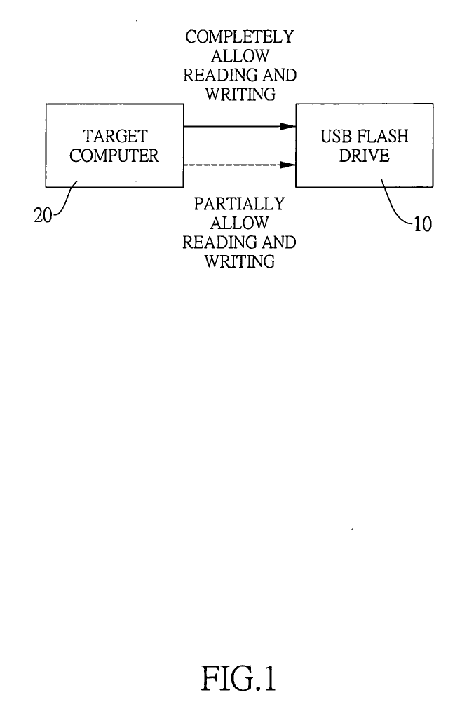

A read-only protection method for removable storage medium in accordance with the present invention is capable of prohibiting pre-designated files to be written to a removable storage medium. The removable storage medium may be a storage device with Universal Serial Bus (USB) interface, such as a USB flash drive, a hard disk having USB interface or the like. The method of the present invention may be performed by the removable storage medium or a target computer to which the removable storage medium is connected. With reference to FIG. 1, the method of the present invention is performed by a removable storage medium, for example an USB flash drive (10) in a preferred embodiment.

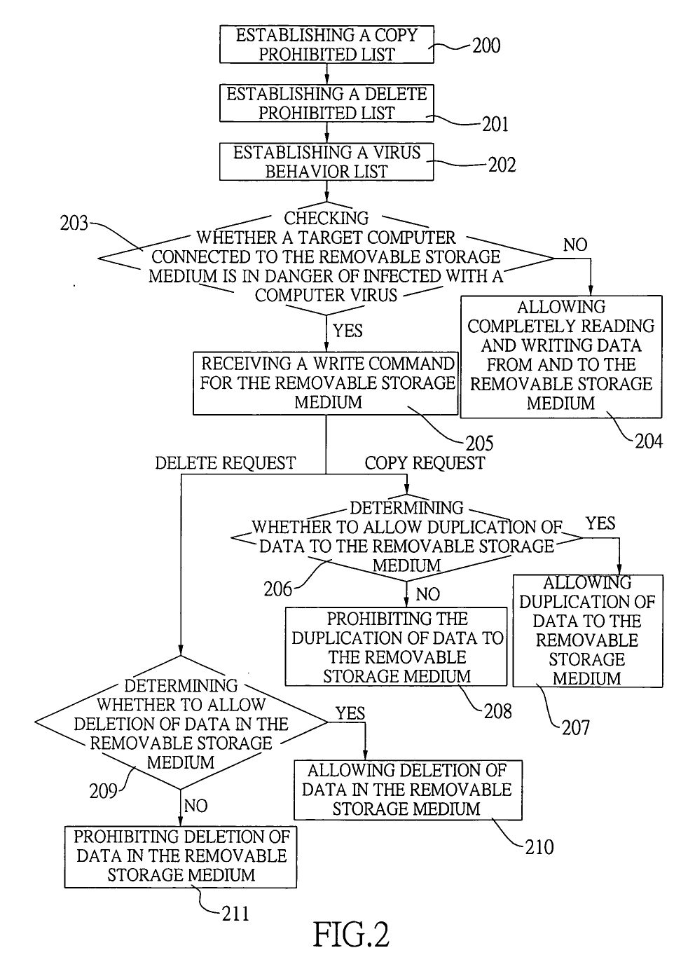

With further reference to FIG. 2, the method of the present invention comprises steps of establishing a copy prohibited list (200), establishing a delete prohibited list (201), establishing a virus behavior list (202), checking whether a target computer connected to the removable storage medium is in danger of infected with a computer virus (203), allowing completely reading and writing data from and to the removable storage medium (204) if the target computer (20) is not in danger of infected with a computer virus, receiving a write command for the removable storage medium (205), determining whether to allow duplication of data to the removable storage medium (206) and determining whether to allow deletion of data in the removable storage medium (209).

In the step of establishing a copy prohibited list (200), the copy prohibited list stores filenames of copy prohibited data. The filename of each copy prohibited data may include filename basename, filename extension or the both. Because most computer viruses infect files having filename extensions such as, but not limited to .exe, .com, .pif, .lnk or the like, the filenames of the copy prohibited data are the filename extensions in this embodiment to exemplify the invention.

To prevent important files or directories being deleted by computer viruses, a delete prohibited list is created to record names of delete prohibited data in the step of establishing a delete prohibited list (201). The names of delete prohibited data may be complete filenames, filename extensions, directory paths or the like.

In the step of establishing a virus behavior list (202), the virus behavior list stores virus behavior data. Each virus behavior data comprises a virus characteristic code and a path indicating a location of the virus characteristic code in system settings of an operating system. To exemplify the invention, the operating system and the computer virus are assumed to be Microsoft Windows operating system and “Virus.Win32.AutoRun.ah”. Windows Registry is a configuration database and stores the system settings on Microsoft Windows operating systems. The “Virus.Win32.AutoRun.ah” computer virus adds a virus string, such as a path of a link executable file “‘Worms’=‘%System%\logon.bat’” to the path “HKLM\SOFTWARE\Microsoft\Windows\CurrentVersion\RunOnce” in the Windows Registry to ensure that the computer virus is launched automatically when the operating system is rebooted. The virus string is the virus characteristic code, and the path “HKLM\SOFTWARE\Microsoft\Windows\ CurrentVersion\RunOnce” is the path indicating the location of the virus characteristic code in the Windows Registry.

The step of checking whether a target computer connected to the removable storage medium is in danger of infected with a computer virus (203) may be implemented with, but not limit to the following solutions.

1. Checking whether the target computer (20) connects to Internet.

If the target computer (20) cannot connect to Internet, neither the operating system nor an antivirus software can be updated through Internet, or the antivirus software cannot be activated. The method of the present invention checks whether the target computer (20) connects to Internet to determine whether the target computer (20) is in danger of infected with a computer virus. If the target computer (20) cannot connect to Internet, the target computer (20) is in danger of infected with a computer virus. Otherwise, the target computer (20) is not in danger of infected with a computer virus. A preferred embodiment for checking whether the target computer (20) connects to Internet is to use application programming interface (API) of the operating system. API is provided by the operating system provider for programmers to program a computer to retrieve status of the operating system.

2. Checking whether the operating system of the target computer (20) is up to date.

The operating system provider delivers latest security update every other period to fix security of the operating system. For example, Microsoft Windows operating system has a function named Windows Update that provides updates for the Microsoft Windows operating system. The method of the present invention checks whether the operating system of the target computer (20) is up to date to determine whether the target computer (20) is in danger of infected with a computer virus. If the operating system of the target computer (20) is not up to date, the target computer (20) is in danger of infected with a computer virus. Otherwise, the target computer (20) is not in danger of infected with a computer virus. A preferred embodiment for checking whether the operating system of the target computer (20) is up to date is to use API of the operating system.

3. Checking whether the antivirus software installed to the target computer (20) activates.

The method of the present invention checks whether the antivirus software installed to the target computer (20) activates to determine whether the target computer (20) is in danger of infected with a computer virus. If the antivirus software does not activate, the target computer (20) is in danger of infected with a computer virus. Otherwise, the target computer (20) is not in danger of infected with a computer virus. A preferred embodiment for checking whether the antivirus software activates is to use API of the operating system.

4. Checking whether the system settings of the operating system of the target computer (20) have matching virus behavior data as recorded in the virus behavior list.

The method of the present invention checks whether the system settings of the operating system of the target computer (20) have matching virus behavior data as recorded in the virus behavior list to determine whether the target computer (20) is in danger of infected with a computer virus. If the system settings of the operating system of the target computer (20) have matching virus behavior data as recorded in the virus behavior list, the target computer (20) is in danger of infected with a computer virus. Otherwise, the target computer (20) is not in danger of infected with a computer virus. A preferred embodiment for checking whether the system settings of the operating system of the target computer (20) include virus behavior data as recorded in the virus behavior list may be to use the API of the operating system or launch the system settings of the operating system to check thereto directly.

If the target computer (20) is not in danger of infected with a computer virus, the step of allowing completely reading and writing data from and to the removable storage medium (204) is subsequently proceeded.

Because most file systems, such as File Allocation Table (FAT) file system, write 0 to the list of disk clusters occupied by the file in the file allocation table to mark those list of disk clusters available, write commands issued by the operating system are also capable of deletion of data. Therefore, in the step of receiving a write command for the removable storage medium (205), the write command may comprise either a copy request or a delete request. The copy request intends to duplicate target data to the removable storage medium. The copy request further comprises filenames of the target data, and the filename of each target data is complete filename in this embodiment. The delete request intends to erase purpose data in the removable storage medium. The delete request further comprises names of the purpose data, and the name of each purpose data may be complete filename, filename extension or directory path.

In the step of determining whether to allow duplication of data to the removable storage medium (206), the method of the present invention determines whether the filenames of the target data in the copy request match the filenames of the copy prohibited data in the copy prohibited list. If the filenames do not match, a step of allowing duplication of data to the removable storage medium (207) is proceeded to duplicate the target data from the target computer (20) to the removable storage medium. Otherwise, a step of prohibiting duplication of data to the removable storage medium (208) is proceeded to prohibit duplicating the target data from the target computer (20) to the removable storage medium.

In the step of determining whether to allow deletion of data in the removable storage medium (209), the method of the present invention determines whether the names of the purpose data in the delete request match the names of delete prohibited data in the delete prohibited list. If the names do not match, a step of allowing deletion of data in the removable storage medium (210) is proceeded to delete the purpose data in the removable storage medium. Otherwise, a step of prohibiting deletion of data in the removable storage medium (211) is proceeded to prohibit deleting the purpose data in the removable storage medium.

Based on the foregoing descriptions, no matter whether the method of the present invention is performed by the removable storage medium such as the USB flash drive (10) or by the target computer (10), the method of the present invention is proceeded when the USB flash drive (10) is connected to the target computer (20). If the target computer (20) is in danger of infected with a computer virus, only data having filenames matching the filenames of the copy prohibited data stored in the copy prohibited list are not allowed to be copied to the removable storage medium, or only data in the removable storage medium having names matching the names of the delete prohibited data stored in the delete prohibited list are prohibited to be deleted. In other words, data having unmatching filenames to the copy prohibited data can still be copied to the removable storage medium, or data in the removable storage medium having unmatching names to the delete prohibited data can still be deleted. Consequently, the method of the present invention prohibits pre-designated files from being copied to or deleted from the removable storage medium.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A read-only protection method for removable storage medium comprising steps of:
establishing a copy prohibited list that stores filenames of copy prohibited data;
receiving a write command for the removable storage medium, and the write command comprising a copy request that intends to duplicate target data to the removable storage medium, and the copy request comprises filenames of the target data;
determining whether the filenames of the target data in the copy request match the filenames of the copy prohibited data in the copy prohibited list;
allowing duplication of the target data to the removable storage medium if the filenames of the target data in the copy request do not match the filenames of the copy prohibited data in the copy prohibited list; and
prohibiting duplication of the target data to the removable storage medium if the filenames of the target data in the copy request match the filenames of the copy prohibited data in the copy prohibited list.

2. The method as claimed in claim 1 further comprising steps of:
checking whether a target computer connected to the removable storage medium is in danger of infected with a computer virus after establishing a copy prohibited list;
continuing receiving a write command for the removable storage medium if the target computer is in danger of infected with a computer virus; and
allowing completely reading and writing data from and to the removable storage medium if the target computer is not in danger of infected with a computer virus.

3. The method as claimed in claim 2, wherein
the step of checking whether a target computer connected to the removable storage medium is in danger of infected with a computer virus comprises checking whether the target computer is connected to Internet;
the target computer is in danger of infected with a computer virus if the target computer is not connected to Internet; and
the target computer is not in danger of infected with a computer virus if the target computer is connected to Internet.

4. The method as claimed in claim 2, wherein
the step of checking whether a target computer connected to the removable storage medium is in danger of infected with a computer virus comprises checking whether an operating system of the target computer is up to date;
the target computer is in danger of infected with a computer virus if the operating system of the target computer is not up to date; and
the target computer is not in danger of infected with a computer virus if the operating system of the target computer is up to date.

5. The method as claimed in claim 2, wherein
the step of checking whether a target computer connected to the removable storage medium is in danger of infected with a computer virus comprises checking whether an antivirus software installed to the target computer activates;
the target computer is in danger of infected with a computer virus if the antivirus software installed to the target computer does not activate; and
the target computer is not in danger of infected with a computer virus if the antivirus software installed to the target computer activates.

6. The method as claimed in claim 2 further comprising a step of establishing a virus behavior list, wherein:
the virus behavior list stores virus behavior data, and each virus behavior data comprises a virus characteristic code and a path indicating a location of the virus characteristic code in system settings of an operating system of the target computer;
the step of checking whether a target computer connected to the removable storage medium is in danger of infected with a computer virus comprises checking whether the system settings of the operating system of the target computer have matching virus behavior data as recorded in the virus behavior list;
the target computer is in danger of infected with a computer virus if the system settings of the operating system of the target computer have matching virus behavior data as recorded in the virus behavior list; and
the target computer is not in danger of infected with a computer virus if the system settings of the operating system of the target computer do not have matching virus behavior data as recorded in the virus behavior list.

7. The method as claimed in claim 1 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.

8. The method as claimed in claim 2 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.

9. The method as claimed in claim 3 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.

10. The method as claimed in claim 4 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.

11. The method as claimed in claim 5 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.

12. The method as claimed in claim 6 further comprising steps of establishing a delete prohibited list and determining whether to allow deletion of data in the removable storage medium, wherein:
the delete prohibited list stores names of delete prohibited data;
the write command either comprises the copy request or further comprises a delete request having names of purpose data in the removable storage medium;
the step of determining whether to allow deletion of data in the removable storage medium is proceeded if the write command comprises a delete request, and the step of determining whether to allow deletion of data in the removable storage medium comprises determining whether the names of the purpose data delete request match the names of the delete prohibited data in the delete prohibited list;
a step of allowing deletion of the purpose data in the removable storage medium is proceeded if the names of the purpose data in the delete request do not match the names of delete prohibited data in the delete prohibited list; and
a step of prohibiting deletion of the purpose data in the removable storage medium is proceeded if the names of the purpose data in the delete request match the names of delete prohibited data in the delete prohibited list.
